(19) United States
(12) Patent Application Publication
(10) Pub. No.: US 2025/0244625 A1
(43) Pub. Date: Jul. 31, 2025

(54) DISPLAY DEVICE AND DISPLAY SYSTEM

(71) Applicant: Japan Display Inc., Tokyo (JP)

(72) Inventor: Toshiharu MATSUSHIMA, Tokyo (JP)

(73) Assignee: Japan Display Inc., Tokyo (JP)

(21) Appl. No.: 19/019,631

(22) Filed: Jan. 14, 2025

(30) Foreign Application Priority Data
Jan. 26, 2024 (JP) 2024-010514

(51) Int. Cl. G02F 1/1362

(52) U.S. Cl. CPC G02F 1/136286; G02F 1/136209

(57) ABSTRACT

According to one aspect, a display device includes an array substrate, a counter substrate, and a liquid crystal layer. The array substrate includes signal lines, scanning lines, a common electrode overlapping pixel electrodes, and a conductive layer having a grid shape and a light-blocking property. The conductive layer includes a frame portion overlapping the signal lines and the scanning lines, and a division line portion dividing the pixel into two sections of a first section and a second section. The common electrode includes a first slit and a second slit for each pixel. A gap between a first side and a second side of the first slit gradually decreases toward the second slit. A gap between a third side and a fourth side of the second slit gradually decreases toward the first slit. The division line portion is provided between the first/third sides and between the second/fourth sides.

### CROSS-REFERENCE TO RELATED APPLICATION

This application claims the benefit of priority from Japanese Patent Application No. 2024-010514 filed on Jan. 26, 2024, the entire contents of which are incorporated herein by reference.

### BACKGROUND

### 1. Technical Field

The present disclosure relates generally to a display device and a display system.

### 2. Description of the Related Art

Patent documents JP-A-2014-232136 and JP-A-2019-113584 disclose display devices for improving response speed and transmittance.

In JP-A-2014-232136, if pixels are made finer for higher definition, it is difficult to form comb teeth of electrodes. In JP-A-2019-113584, liquid crystal domains and dark regions are formed. The dark regions are regions where the orientation of liquid crystal molecules hardly changes. In JP-A-2019-113584, slits are provided inside an opening that is surrounded by signal lines and scanning lines. In JP-A-2019-113584, however, if pixels are made finer for higher definition, the slits overlap the signal lines or the scanning lines, and the transmittance may possibly be reduced.

For the foregoing reasons, there is a need for enhancing transmittance even if pixels are made finer for higher definition.

### SUMMARY

A display device according to one aspect of the present disclosure includes an array substrate, a counter substrate facing the array substrate, and a liquid crystal layer including a liquid crystal molecule between the array substrate and the counter substrate. The array substrate includes: a plurality of signal lines spaced apart in a first direction; a plurality of scanning lines spaced apart in a second direction; a plurality of pixel electrodes, each pixel electrode being provided for each opening of a pixel surrounded by two adjacent signal lines and two adjacent scanning lines; a plurality of semiconductors, each semiconductor being provided for each pixel; a common electrode overlapping the pixel electrodes via an insulating film; and a conductive layer stacked directly on the common electrode. The conductive layer has a grid shape and having a light-blocking property. The conductive layer includes: a frame portion overlapping the signal lines and the scanning lines; and a division line portion dividing the pixel into two sections of a first section and a second section. The common electrode includes a first slit and a second slit for each pixel. The first slit has at least a first side and a second side. The second side faces the first side in plan view and is provided in the first section. The second slit has at least a third side and a fourth side. The fourth side faces the third side in plan view and is provided in the second section. A gap between the first side and the second side gradually decreases toward the second slit. A gap between the third side and the fourth side gradually decreases toward the first slit. The division line portion is provided between the first side and the third side and between the second side and the fourth side.

A display system according to another aspect of the present disclosure includes: a lens; the above-described display device; and a control device configured to output an image to the display device.

### BRIEF DESCRIPTION OF THE DRAWINGS

FIG. 1 is a configuration diagram of an example of a display system according to a first embodiment;

FIG. 2 is a schematic of an example of the relative relation between a display device and the eyes of a user;

FIG. 3 is a block diagram of an example of the configuration of the display system according to the first embodiment;

FIG. 4 is a circuit diagram of a pixel array in a display region according to the first embodiment;

FIG. 5 is a schematic of an example of a display panel according to the first embodiment;

FIG. 6 is an enlarged schematic of part of the display region according to the first embodiment;

FIG. 7 is a sectional view schematically illustrating the section along line VII-VII′ of FIG. 6;

FIG. 8 is a sectional view schematically illustrating the boundary between the display region and a peripheral region according to the first embodiment;

FIG. 9 is a sectional view schematically illustrating the section along line IX-IX′ of FIG. 8;

FIG. 10 is a plan view schematically illustrating the relation between slits and liquid crystal domains;

FIG. 11 is a plan view schematically illustrating the relation between the slits and the liquid crystal domains according to a comparative example;

FIG. 12 is an enlarged schematic of part of the display region according to a second embodiment; and

FIG. 13 is a sectional view schematically illustrating the section along line XIII-XIII′ of FIG. 12.

### DETAILED DESCRIPTION

Exemplary aspects (embodiments) to embody the present invention are described below in detail with reference to the accompanying drawings. The contents described in the embodiments below are not intended to limit the present disclosure. Components described below include components easily conceivable by those skilled in the art and components substantially identical therewith. Furthermore, the components described below may be appropriately combined. What is disclosed herein is given by way of example only, and appropriate modifications made without departing from the spirit of the invention and easily conceivable by those skilled in the art naturally fall within the scope of the present disclosure. To simplify the explanation, the drawings may possibly illustrate the width, the thickness, the shape, and other elements of each unit more schematically than the actual aspect. These elements, however, are given by way of example only and are not intended to limit interpretation of the present disclosure. In the present specification and the figures, components similar to those previously described with reference to previous figures are denoted by like reference numerals, and detailed explanation thereof may be appropriately omitted.

### First Embodiment

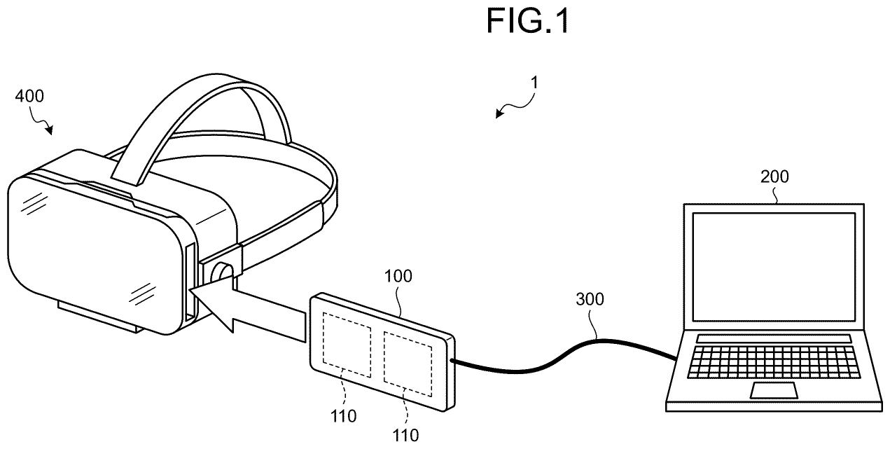

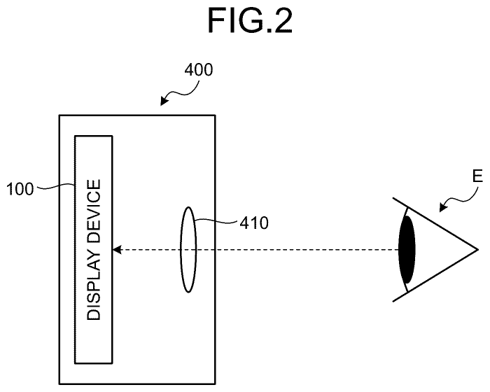

FIG. 1 is a configuration diagram of an example of a display system according to a first embodiment. FIG. 2 is a schematic of an example of the relative relation between a display device and the eyes of a user.

A display system 1 according to the present embodiment is a display system that changes images in synchronization with movement of the user. The display system 1 is, for example, a virtual reality (VR) system that three-dimensionally displays VR images indicating three-dimensional objects or the like in a virtual space and changes the three-dimensional images in accordance with the direction (position) of the user's head, thereby creating a sense of virtual reality for the user.

The display system 1 includes, for example, a display device 100 and a control device 200. The display device 100 and the control device 200 can receive and transmit information (signals) via a cable 300. Examples of the cable 300 include, but are not limited to, a universal serial bus (USB) cable, a high-definition multimedia interface (HDMI) (registered trademark) cable, etc. The display device 100 and the control device 200 may be capable of receiving and transmitting information through wireless communications.

The display device 100 is supplied with electric power from the control device 200 via the cable 300. The display device 100 may include, for example, a power receiver supplied with electric power from a power supply unit of the control device 200 via the cable 300. In this case, display panels 110, a sensor 120, and other components of the display device 100 may be driven using the electric power supplied from the control device 200. With this configuration, the display device 100 does not require a battery or the like and can be provided as a more reasonable and lighter display device 100. Alternatively, a wearable tool 400 or the display device 100 may be provided with a battery to supply electric power to the display device.

The display device 100 includes display panels. In one example, the display panel is a liquid crystal display.

The display device 100 is fixed to the wearable tool 400. Examples of the wearable tool 400 include, but are not limited to, a headset, goggles, a helmet and a mask that cover both eyes of the user, etc. The wearable tool 400 is worn on the user's head. When the wearable tool 400 is worn, it is positioned in front of the user so as to cover both eyes of the user. The wearable tool 400 functions as an immersive wearable tool by positioning the display device 100 fixed inside in front of both eyes of the user. The wearable tool 400 may include an output unit that outputs sound signals or the like supplied by the control device 200. The wearable tool 400 may incorporate the functions of the control device 200.

While the display device 100 in the example illustrated in FIG. 1 is slotted into the wearable tool 400, it may be fixed to the wearable tool 400. In other words, the display system may be composed of a wearable display device including the wearable tool 400 and the display device 100, and the control device 200.

As illustrated in FIG. 2, the wearable tool 400 includes, for example, a lens 410 corresponding to both eyes of the user. The lens 410 is a magnifying lens to form an image in the eyes of the user. When the wearable tool 400 is worn on the user's head, the lens 410 is positioned in front of the user's eyes E. The user visually recognizes a display region of the display device 100 magnified by the lens 410. Therefore, the display device 100 needs to increase the resolution to clearly display an image (screen). While the configuration according to the present disclosure includes one lens, it may include, for example, a plurality of lenses, and the display device 100 may be positioned at a position other than in front of the eyes.

The control device 200 displays, for example, images on the display device 100. The control device 200 may be an electronic apparatus, such as a personal computer and a gaming device. Examples of the virtual images include, but are not limited to, computer graphic video images, 360-degree real video images, etc. The control device 200 outputs a three-dimensional image created using the parallax of both eyes of the user to the display device 100. The control device 200 outputs images for the right eye and the left eye that follow the direction of the user's head to the display device 100.

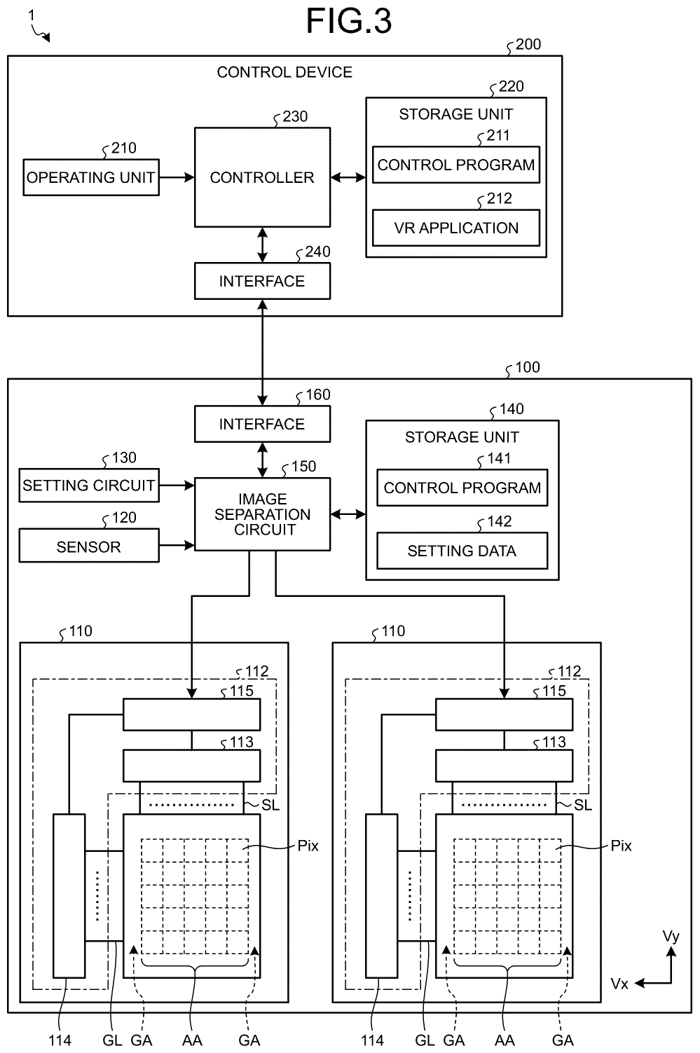

FIG. 3 is a block diagram of an example of the configuration of the display system according to the first embodiment. As illustrated in FIG. 3, the display device 100 includes two display panels 110, a sensor 120, a setting circuit 130, a storage unit 140, an image separation circuit 150, and an interface 160. In the storage unit 140, a control program 141, setting data 142, etc. are stored.

The display device 100 is composed of two display panels 110. One of the display panels 110 is used as the display panel 110 for the left eye, and the other is used as the display panel 110 for the right eye.

The two display panels 110 each have a display region AA and a display control circuit 112. The display panel 110 includes a light source device, not illustrated, that irradiates the display region AA with light from behind.

In the display region AA, P₀×Q₀ pixels Pix (P₀ pixels Pix in the row direction and Q₀ pixels Pix in the column direction) are arrayed in a two-dimensional matrix (row-column configuration). In the present embodiment, P₀ is 2880, and Q₀ is 1700. FIG. 3 schematically illustrates the array of the pixels Pix. The array of the pixels Pix will be described later in detail. The pixels of the display device are visually recognized through the lens. For this reason, the pixel pitch is set to, for example, 3 μm to 10 μm, and the display region AA is composed of a high-definition array of the pixels Pix. The display region AA is surrounded by a peripheral region GA.

The display panel 110 includes scanning lines extending in an X-direction and signal lines extending in a Y-direction that intersects the X-direction. The display panel 110 includes, for example, 2880 signal lines SL and 1700 scanning lines GL. In the display panel 110, the pixel Pix is provided in the region surrounded by the signal lines SL and the scanning lines GL. Each pixel Pix includes a switching element SW (thin-film transistor (TFT)) coupled to the signal line SL and the scanning line GL, and a pixel electrode coupled to the switching element SW. One scanning line GL is coupled to a plurality of pixels Pix arranged in the extending direction of the scanning line GL. One signal line SL is coupled to a plurality of pixels Pix arranged in the extending direction of the signal line SL.

The display region AA in one of the two display panels 110 is for the right eye, and the display region AA of the other display panel 110 is for the left eye. The first embodiment describes a case where the display panel 110 includes the two display panels 110 for the left eye and the right eye. The display device 100, however, does not necessarily include two display panels 110 as described above. The display device 100 may include, for example, one display panel 110. In this case, the display region of the one display panel 110 may be divided into two parts such that the right half region displays images for the right eye and the left half region displays images for the left eye.

The display control circuit 112 includes a driver integrated circuit (IC) 115, a signal line coupling circuit 113, and a scanning line drive circuit 114. The signal line coupling circuit 113 is electrically coupled to the signal lines SL. The driver IC 115 causes the scanning line drive circuit 114 to control ON/OFF of the switching elements (e.g., TFT) for controlling the operation (light transmittance) of the pixels Pix. The scanning line drive circuit 114 is electrically coupled to the scanning lines GL.

The sensor 120 detects information that enables estimation of the direction of the user's head. In one example, the sensor 120 detects information representing the movement of the display device 100 and/or the wearable tool 400. Then, the display system 1 estimates the direction of the head of the user who wears the display device 100 on the head, based on the information representing the movement of the display device 100 and/or the wearable tool 400.

The sensor 120 detects the information that enables estimation of the direction of the line of sight, by using, for example, at least one of the angle, acceleration, angular velocity, azimuth, and distance of the display device 100 and/or the wearable tool 400. Examples of the sensor 120 include, but are not limited to, a gyro sensor, an acceleration sensor, an azimuth sensor, etc. The sensor 120 may detect the angle and angular velocity of the display device 100 and/or the wearable tool 400 by a gyro sensor, for example. The sensor 120 may detect the direction and magnitude of acceleration acting on the display device 100 and/or the wearable tool 400 by an acceleration sensor. The sensor 120 may detect the azimuth of the display device 100 by an azimuth sensor. The sensor 120 may detect the movement of the display device 100 and/or the wearable tool 400 by a distance sensor or a global positioning system (GPS) receiver. The sensor 120 may be any other sensor, such as an optical sensor, or a combination of a plurality of sensors, as long as it is a sensor that detects the direction of the user's head, changes in the line of sight, movement, or the like. The sensor 120 is electrically coupled to the image separation circuit 150 via the interface 160, which will be described later.

The image separation circuit 150 receives image data for the left eye and image data for the right eye transmitted from the control device 200 via the cable 300. Then, the image separation circuit 150 transmits the image data for the left eye to the display panel 110 that displays images for the left eye, and transmits the image data for the right eye to the display panel 110 that displays images for the right eye.

The interface 160 includes a connector to which the cable 300 (FIG. 1) is coupled. The interface 160 receives signals from the control device 200 via the coupled cable 300. The image separation circuit 150 outputs the signals received from the sensor 120 to the control device 200 via the interface 160 and an interface 240. The signals received from the sensor 120 include the information that enables estimation of the direction of the line of sight described above. Alternatively, the signals received from the sensor 120 may be output directly to a controller 230 of the control device 200 via the interface 160. The interface 160 may be a wireless communication device, and may transmit and receive information to and from the control device 200 through wireless communications.

The control device 200 includes an operating unit 210, a storage unit 220, the controller 230, and the interface 240.

The operating unit 210 receives operations of the user. The operating unit 210 is an input device, such as a keyboard, buttons, and a touch screen. The operating unit 210 is electrically coupled to the controller 230. The operating unit 210 outputs information corresponding to the operations to the controller 230.

The storage unit 220 stores computer programs and data. The storage unit 220 temporarily stores the results of processing by the controller 230. The storage unit 220 includes a storage medium. Examples of the storage medium include, but are not limited to, ROM, RAM, a memory card, an optical disc, a magneto-optical disc, etc. The storage unit 220 may store data of images to be displayed on the display device 100.

The storage unit 220 stores a control program 211, a VR application 212, etc. The control program 211 can implement functions related to various controls for operating the control device 200. The VR application 212 can implement functions to display virtual reality images on the display device 100. The storage unit 220 can store various kinds of information, such as data indicating the detection results of the sensor 120, received from the display device 100.

Examples of the controller 230 include, but are not limited to, a micro control unit (MCU), a central processing unit (CPU), etc. The controller 230 can collectively control the operations of the control device 200. The various functions of the controller 230 are implemented based on the control by the controller 230.

The controller 230 includes, for example, a graphics processing unit (GPU) that generates images to be displayed. The GPU generates images to be displayed on the display device 100. The controller 230 outputs the images generated by the GPU to the display device 100 via the interface 240. While the controller 230 of the control device 200 according to the present embodiment includes a GPU, the present embodiment is not limited thereto. In one example, the GPU may be provided to the display device 100 or the image separation circuit 150 of the display device 100. In this case, the display device 100 acquires data from the control device 200 or an external electronic apparatus, and the GPU generates the images based on the acquired data.

The interface 240 includes a connector to which the cable 300 (refer to FIG. 1) is coupled. The interface 240 receives signals from the display device 100 via the cable 300. The interface 240 outputs signals received from the controller 230 to the display device 100 via the cable 300. In one example, the interface 240 may be a wireless communication device, and may transmit and receive information to and from the display device 100 by wireless communications.

By executing the VR application 212, the controller 230 displays an image corresponding to the movement of the user (display device 100) on the display device 100. In response to detecting a change in the user (display device 100) while the image is being displayed on the display device 100, the controller 230 changes the image being displayed on the display device 100 to an image corresponding to the direction of the change. When starting to create an image, the controller 230 creates an image based on a reference point of view and a reference line of sight in the virtual space. In response to detecting a change in the user (display device 100), the controller 230 changes, in accordance with the movement of the user (display device 100), the point of view or the line of sight when creating the image being displayed from the reference point view or the reference line of sight. The controller 230 displays, on the display device 100, an image based on the changed point of view or line of sight.

In one example, the controller 230 detects the movement of the user's head to the right direction based on the detection results of the sensor 120. In this case, the controller 230 changes the currently displayed image to an image corresponding to the line of sight that has been moved to the right direction. The user can visually recognize the image in the right direction with respect to the image that was displayed on the display device 100.

In response to detecting the movement of the display device 100 based on the detection results of the sensor 120, the controller 230 changes the image in accordance with the detected movement. If the controller 230 detects that the display device 100 has moved forward, it changes the currently displayed image to an image to be displayed when the display device 100 moves forward. If the controller 230 detects that the display device 100 has moved backward, it changes the currently displayed image to an image to be displayed when the display device 100 moves backward. The user can visually recognize the image in the direction of his/her movement from the image being displayed on the display device 100.

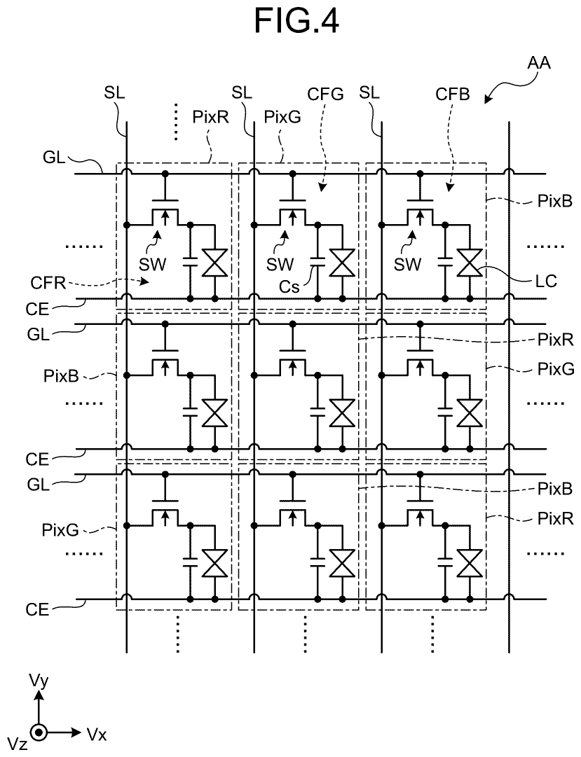

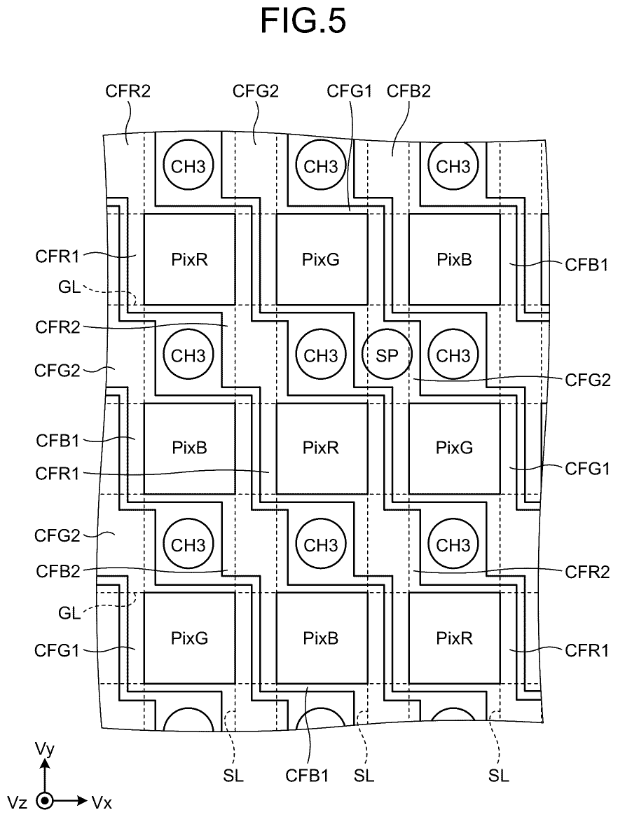

FIG. 4 is a circuit diagram of the pixel array in the display region according to the first embodiment. FIG. 5 is a schematic of an example of the display panel according to the first embodiment. In the present disclosure, the scanning lines GL and the signal lines SL do not necessarily intersect at right angles, but they intersect at right angles in FIG. 4 for the convenience of explanation.

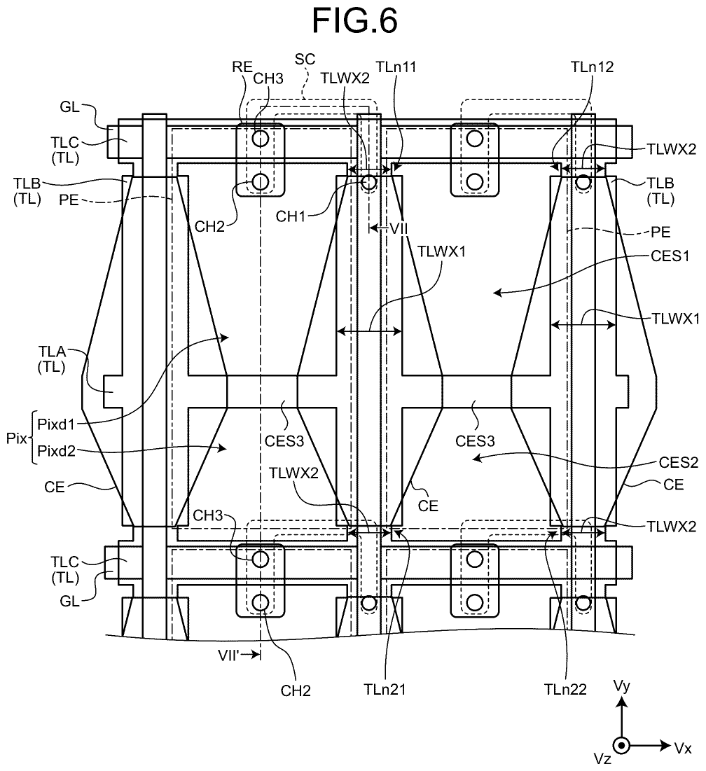

The display region AA is provided with the switching elements SW of pixels PixR, PixG, and PixB, the signal lines SL, the scanning lines GL, and other components as illustrated in FIG. 4. The signal line SL is wiring for supplying pixel signals to pixel electrodes PE (refer to FIG. 6). The scanning line GL is wiring for supplying gate signals that drive the switching elements SW.

As illustrated in FIG. 4, the pixels PixR, PixG, and PixB each include the switching element SW and capacitance of a liquid crystal layer LC. The switching element SW is composed of a thin-film transistor and is composed of an n-channel metal oxide semiconductor (MOS) TFT in this example. An insulating film is provided between the pixel electrode PE and a common electrode CE, which will be described later, and holding capacitance Cs illustrated in FIG. 4 is formed between the pixel electrode PE and the common electrode CE.

In color filters CFR1, CFG1, and CFB1 illustrated in FIG. 5, color regions colored in three colors of red (first color: R), green (second color: G), and blue (third color: B) are periodically arrayed. The three color regions, R, G, and B correspond to the pixels PixR, PixG, and PixB, respectively, illustrated in FIG. 4 described above. A set of the pixels PixR, PixG, and PixB corresponding to the three color regions serves as a pixel. The color filter may include four or more color regions. The pixels PixR, PixG, and PixB may be referred to as sub-pixels.

The color filters CFR1, CFG1, and CFB1 illustrated in FIG. 5 are each provided to the opening surrounded by two signal lines SL and two scanning lines GL.

As illustrated in FIGS. 4 and 5, a direction Vx (first direction), a direction Vy (second direction), and a direction Vz, which are orthogonal to each other, are defined. The pixel PixR is interposed between the pixel PixB and the pixel PixG in the direction Vx (first direction) and between the pixel PixB and the pixel PixG in the direction Vy (second direction).

The pixel PixG is interposed between the pixel PixR and the pixel PixB in the direction Vx and between the pixel PixR and the pixel PixB in the direction Vy.

The pixel PixB is interposed between the pixel PixG and the pixel PixR in the direction Vx and between the pixel PixG and the pixel PixR in the direction Vy.

The pixel PixR, the pixel PixG, and the pixel PixB are repeatedly arrayed in this order in the direction Vx. The pixel PixR, the pixel PixB, and the pixel PixG are repeatedly arrayed in this order in the direction Vy. In the arrangement in the direction Vy, the pixel PixR, the pixel PixG, and the pixel PixB may be repeatedly arrayed in this order.

The color filters CFR1 are coupled by a color filter CFR2 in the same red color. By coupling the color filters CFR1 and the color filters CFR2, the color filters in the same color are disposed in an oblique direction intersecting the direction Vx and the direction Vy. Similarly, the color filters CFG1 are coupled by a color filter CFG2 in the same green color, and the color filters CFB1 are coupled by a color filter CFB2 in the same blue color.

The color filter CFR1 and the color filter CFR2 are integrally formed. For the convenience of explanation, the color filter CFR1 and the color filter CFR2 are hereinafter referred to as a color filter CFR when they are not distinguished from each other. Similarly, the color filter CFG1 and the color filter CFG2 are hereinafter referred to as a color filter CFG when they are not distinguished from each other. The color filter CFB1 and the color filter CFB2 are hereinafter referred to as a color filter CFB when they are not distinguished from each other. Furthermore, the color filter CFR, the color filter CFG, and the color filter CFB are referred to as a color filter CF when they are not distinguished from one another.

A spacer SP illustrated in FIG. 5 is a member that regulates the distance between an array substrate SUB1 and a counter substrate SUB2. The material of the spacer SP is acrylic resin, for example. The spacer SP has a cylindrical shape. In FIG. 5, the maximum diameter of the spacer SP is illustrated. The spacer SP does not necessarily have a cylindrical shape and may be formed as, for example, a prismatic spacer. While one spacer is illustrated as an example in FIG. 5, plural spacers are disposed in the actual configuration.

FIG. 6 is an enlarged schematic of part of the display region according to the first embodiment. The pixel Pix illustrated in FIG. 6 is any one of the pixel PixR, the pixel PixG, and the pixel PixB. In the following description, the pixel PixR, the pixel PixG, and the pixel PixB are referred to as the pixels Pix when they are not distinguished from one another.

The signal lines SL are arrayed in the direction Vx in a manner spaced apart from each other. The scanning lines GL are arrayed in the direction Vy in a manner spaced apart from each other. A conductive layer TL overlaps the signal lines SL and the scanning lines GL and has a grid shape in plan view. The common electrode CE is an island-shaped electrode having an octagonal shape. The common electrode CE is made of light-transmitting conductive material, such as indium tin oxide (ITO), indium zinc oxide (IZO), and indium gallium oxide (IGO). The conductive layer TL overlaps the common electrode CE. The conductive layer TL electrically couples plural island-shaped common electrodes CE. The conductive layer TL has lower resistance than the common electrode CE, thereby reducing variations in voltage distribution in each pixel Pix due to voltage drop.

As illustrated in FIG. 6, the conductive layer TL according to the first embodiment has a first frame portion TLB overlapping a plurality of signal lines SL in plan view, a second frame portion TLC overlapping a plurality of scanning lines GL in plan view, and a division line portion TLA positioned between two adjacent scanning lines GL (second frame portion TLC). The division line portion TLA divides the pixel Pix into a first section Pixd1 and a second section Pixd2. Therefore, the light-transmitting region in the opening of the pixel Pix is divided into two regions surrounded by the scanning lines GL and the division line portion TLA (conductive layer TL). As illustrated in FIG. 6, the second section Pixd2 is smaller than the first section Pixd1.

The width TLWX1 of the first frame portion TLB in the direction Vx decreases to the width TLWX2 in the direction Vx at the part coupled to the second frame portion TLC. The width TLWX2 in the direction Vx is larger than the width of the signal line SL in the direction Vx. The width of the second frame portion TLC in the direction Vy is larger than that of the scanning line GL in the direction Vy.

In the pixel Pix, the pixel electrode PE and the switching element SW are provided for each opening surrounded by two signal lines SL and two scanning lines GL. The common electrode CE is a common electrode provided across a plurality of pixels Pix. The common electrode CE has a first slit CES1, a second slit CES2, and a third slit CES3 for each opening surrounded by two signal lines SL and two scanning lines GL.

The first slit CES1, the second slit CES2, and the third slit CES3 are a part not provided with light-transmitting conductive material of the common electrode CE. The first slit CES1, the second slit CES2, and the third slit CES3 overlap the pixel electrode PE. In the following description, the first slit CES1, the second slit CES2, and the third slit CES3 may be collectively referred to as slits CES. The first slit CES1 is formed in the first section Pixd1, and the second slit CES2 is formed in the second section Pixd2.

The substantial slit in the first section Pixd1 is a region not provided with the common electrode CE to the conductive layer TL. Part of the first frame portion TLB is present in the inner part of the first slit CES1. As a result, recesses TLn11 and TLn12 are formed in the narrower part of the first frame portion TLB. The substantial slit in the first section Pixd1 is a combination of a trapezoidal region and rectangular regions.

The substantial slit in the second section Pixd2 is a region not provided with the common electrode CE to the conductive layer TL. Part of the first frame portion TLB is present in the inner part of the second slit CES2. As a result, recesses TLn21 and TLn22 are formed in the narrower part of the first frame portion TLB. The substantial slit in the second section Pixd2 is a combination of a trapezoidal region and rectangular regions.

The third slit CES3 couples the first slit CES1 and the second slit CES2 as a region not provided with the conductive material of the common electrode CE. The third slit CES3 is covered by the division line portion TLA, and the first slit CES1 and the second slit CES2 are divided by the division line portion TLA. The third slit CES3 is covered by the division line portion TLA and does not substantially serve as a slit. The third slit CES3 has a rectangular shape.

As illustrated in FIG. 6, a semiconductor SC is formed in a U-shape. The signal line SL and the semiconductor SC are electrically coupled through a contact hole CH1. The semiconductor SC and a relay electrode RE are electrically coupled through a contact hole CH2. The relay electrode RE and the pixel electrode PE are electrically coupled through a contact hole CH3.

The first section Pixd1 has the contact hole CH3, and the area of the first section Pixd1 is larger than that of the second section Pixd2.

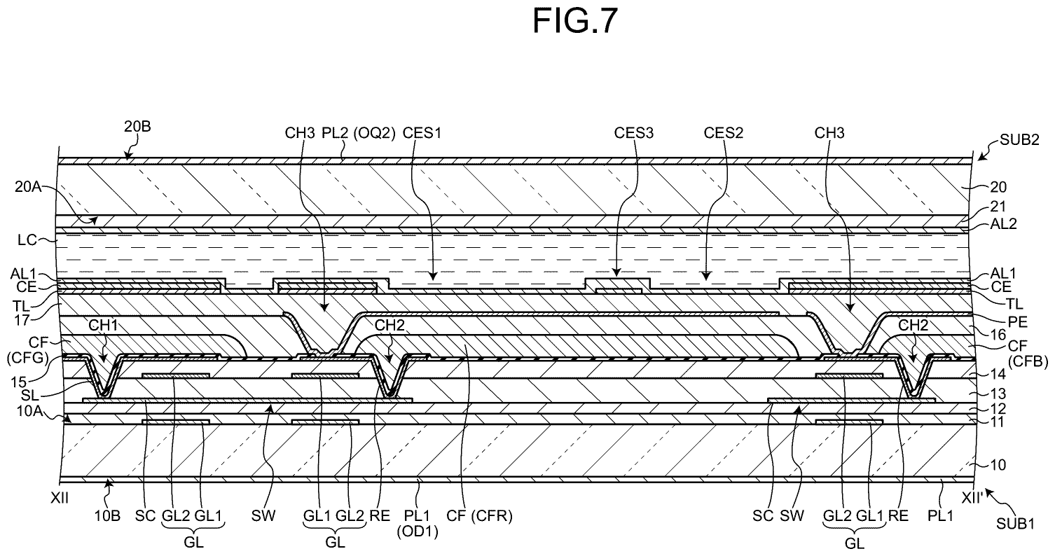

FIG. 7 is a sectional view schematically illustrating the section along line VII-VII′ of FIG. 6. As illustrated in FIG. 5, the color filter CF according to the first embodiment is provided to the array substrate SUB1. The display device 100 has what is called a color filter on array (COA) structure in which the color filter CF, the pixel electrodes PE, and the common electrode CE are provided on the array substrate SUB1.

As illustrated in FIG. 7, the array substrate SUB1 is formed using a first insulating substrate 10 with a light-transmitting property, such as a glass or resin substrate, as a base. The array substrate SUB1 includes a first layer GL1 of the scanning line GL, a first insulating film 11, a second insulating film 12, a third insulating film 13, a fourth insulating film 14, the color filter CF, a fifth insulating film 15, the pixel electrode PE, a sixth insulating film 16, the pixel electrode PE, a seventh insulating film 17, the conductive layer TL, the common electrode CE, a first orientation film AL1, and other components on the surface of the first insulating substrate 10 facing the counter substrate SUB2. In the following description, the direction from the array substrate SUB1 toward the counter substrate SUB2 is referred to as an upper side or simply as up.

The first layer GL1 of the scanning line GL is positioned above the first insulating substrate 10. The first insulating film 11 is positioned on the first layer GL1 of the scanning line GL and an inner surface 10A of the first insulating substrate 10. The second insulating film 12 is positioned on the first insulating film 11. The semiconductor SC is positioned on the second insulating film 12. The third insulating film 13 is positioned on the semiconductor SC and the second insulating film 12. A second layer GL2 of the scanning line GL is positioned on the third insulating film 13. The part of the first layer GL1 and the second layer GL2 of the scanning line GL overlapping the semiconductor SC acts as a gate electrode.

The fourth insulating film 14 is positioned on the second layer GL2 of the scanning line GL and the third insulating film 13. A hole is formed at a position overlapping the semiconductor SC in the third insulating film 13 and the fourth insulating film 14 to form the contact hole CH1. The signal line SL formed on the fourth insulating film 14 is electrically coupled to the semiconductor SC through the contact holes CH1.

A hole is formed at a position overlapping the semiconductor SC in the third insulating film 13 and the fourth insulating film 14 to form the contact hole CH2. The relay electrode RE formed on the fourth insulating film 14 is electrically coupled to the semiconductor SC through the contact holes CH2.

The fifth insulating film 15 is positioned on the signal line SL, the relay electrode RE, and the fourth insulating film 14. The color filter CF is positioned on the fifth insulating film 15. The sixth insulating film 16 is positioned on the color filter CF and the fifth insulating film 15.

A hole is formed at a position overlapping the relay electrode RE in the fifth insulating film 15 and the sixth insulating film 16 to form the contact hole CH3. The pixel electrode PE formed on the sixth insulating film 16 is electrically coupled to the relay electrode RE through the contact holes CH3. The pixel electrode PE is made of light-transmitting conductive material, such as ITO, IZO, and IGO.

The common electrode CE is positioned above the seventh insulating film 17. The common electrode CE is made of light-transmitting conductive material, such as ITO, IZO, and IGO.

The conductive layer TL is positioned on the seventh insulating film 17. The conductive layer TL is a conductor and is electrically coupled to the common electrode CE. Therefore, the resistance per unit area of the common electrode CE and the conductive layer TL is small. The conductive layer TL may be a single layer of metal, such as aluminum (Al). Alternatively, the conductive later TL may be composed of a plurality of metal layers, such as titanium/aluminum/titanium and molybdenum/aluminum/molybdenum, by disposing titanium (Ti) and molybdenum (Mo) on and under aluminum.

The common electrode CE and the seventh insulating film 17 exposed through the first slit CES1 and the second slit CES2 are covered by the first orientation film AL1.

The counter substrate SUB2 includes, as a base body, a second insulating substrate 20 with a light-transmitting property, such as a glass or resin substrate. The counter substrate SUB2 includes an overcoat layer 21 and a second orientation film AL2 on the side of the second insulating substrate 20 facing the array substrate SUB1 (namely, on an inner surface 20A of the second insulating substrate 20).

The array substrate SUB1 and the counter substrate SUB2 are disposed such that the first orientation film AL1 and the second orientation film AL2 face each other. The liquid crystal layer LC is enclosed between the first orientation film AL1 and the second orientation film AL2. The long axis of the liquid crystal molecules is oriented orthogonal or parallel to an initial orientation direction AD illustrated in FIG. 6 by the first orientation film AL1 and the second orientation film AL2. The liquid crystal layer LC is made of negative liquid crystal material with negative dielectric anisotropy or positive liquid crystal material with positive dielectric anisotropy. The orientation of the liquid crystal layer LC is stable when voltage is applied to the liquid crystal layer LC, and the fast response of liquid crystal molecules is easily maintained. If the liquid crystal layer LC is made of positive liquid crystal material, the long axis of the liquid crystal molecules is aligned in a direction parallel to the initial orientation direction AD illustrated in FIG. 6. If the liquid crystal layer LC is made of negative liquid crystal material, the long axis of the liquid crystal molecules is aligned in a direction orthogonal to the initial orientation direction AD illustrated in FIG. 6.

The array substrate SUB1 faces a backlight unit, and the counter substrate SUB2 is positioned on the display surface side. While various kinds of backlight units are applicable, detailed description of their structure is omitted.

A first optical element OD1 including a first polarizing plate PL1 is provided on an outer surface 10B of the first insulating substrate 10 or on the surface facing the backlight unit. A second optical element OD2 including a second polarizing plate PL2 is provided on an outer surface 20B of the second insulating substrate 20 or on the surface on the observation position side. The first polarization axis of the first polarizing plate PL1 and the second polarization axis of the second polarizing plate PL2 are in a crossed-Nicoles positional relation in the Vx-Vy plane. The first optical element OD1 and the second optical element OD2 may include other optical functional elements, such as a retardation plate.

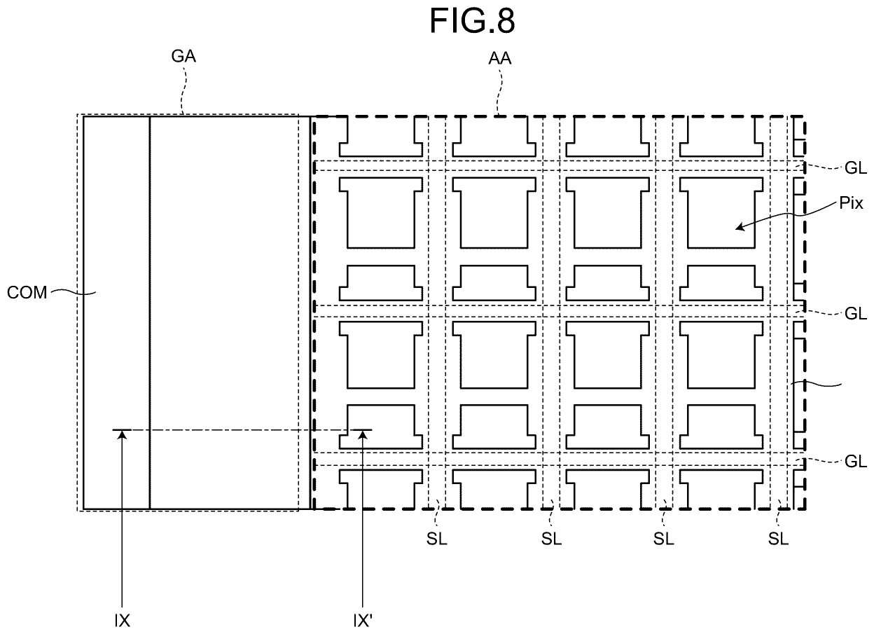

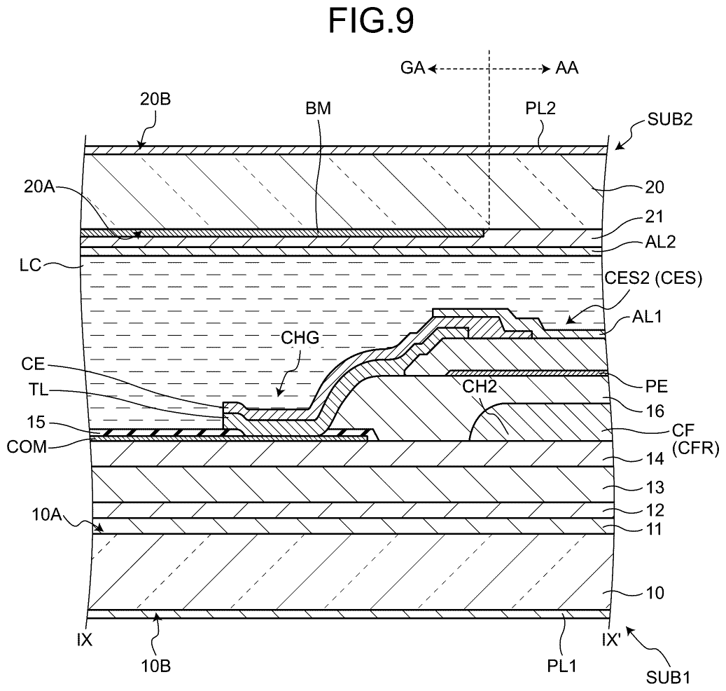

FIG. 8 is a sectional view schematically illustrating the boundary between the display region and the peripheral region according to the first embodiment. FIG. 9 is a sectional view schematically illustrating the section along line IX-IX′ of FIG. 8. As illustrated in FIGS. 8 and 9, wiring COM for supplying a common potential is provided on the fourth insulating film 14 in the peripheral region GA. The fifth insulating film 15 covers and protects the wiring COM. A contact hole CHG is formed in part of the fifth insulating film 15, and the wiring COM is electrically coupled to the conductive layer TL and the common electrode CE drawn from the display region AA through the contact hole CHG.

As illustrated in FIGS. 8 and 9, a light-blocking layer BM is provided to the counter substrate SUB2 in the peripheral region GA and can conceal the peripheral region GA of the array substrate SUB1. While the light-blocking layer BM is not provided to the counter substrate SUB2 in the display region AA in the example illustrated in FIGS. 7 and 9, it may be provided. The light-blocking layer BM is made of black resin material.

In a structure according to a comparative example where the counter substrate SUB2 is provided with the color filters and the light-blocking layer positioned at the boundary between the colors of the color filters unlike the first embodiment, the opening of the pixel Pix on the array substrate is more likely to overlap the position of the light-blocking layer in the display region AA of the counter substrate SUB2 as the pixel Pix is smaller. By contrast, in the COA structure according to the first embodiment illustrated in FIGS. 8 and 9, the display region AA of the counter substrate SUB2 is not provided with the color filters CF or the light-blocking layer positioned at the boundary between the colors of the color filters CF. Therefore, the required level of the accuracy in overlapping the array substrate SUB1 and the counter substrate SUB2 can be lowered.

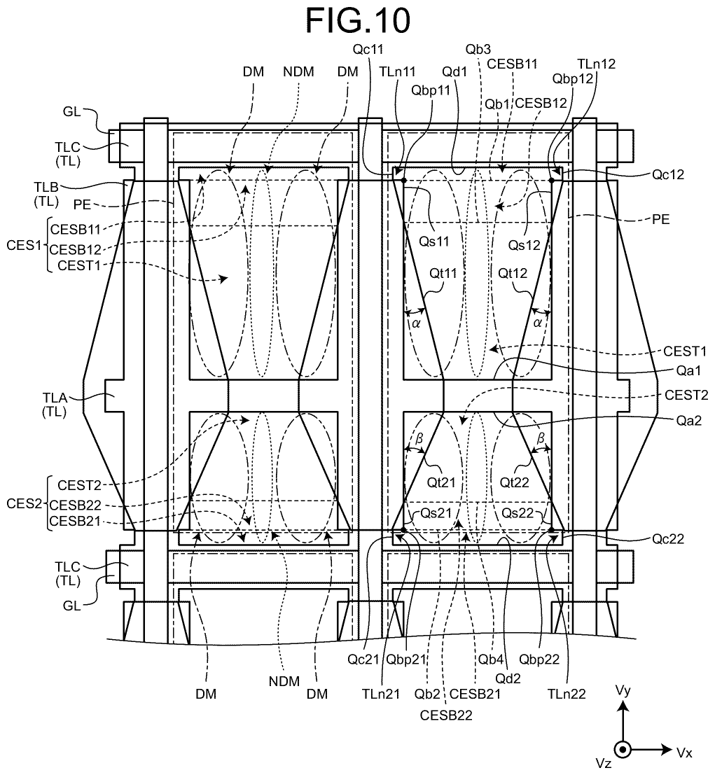

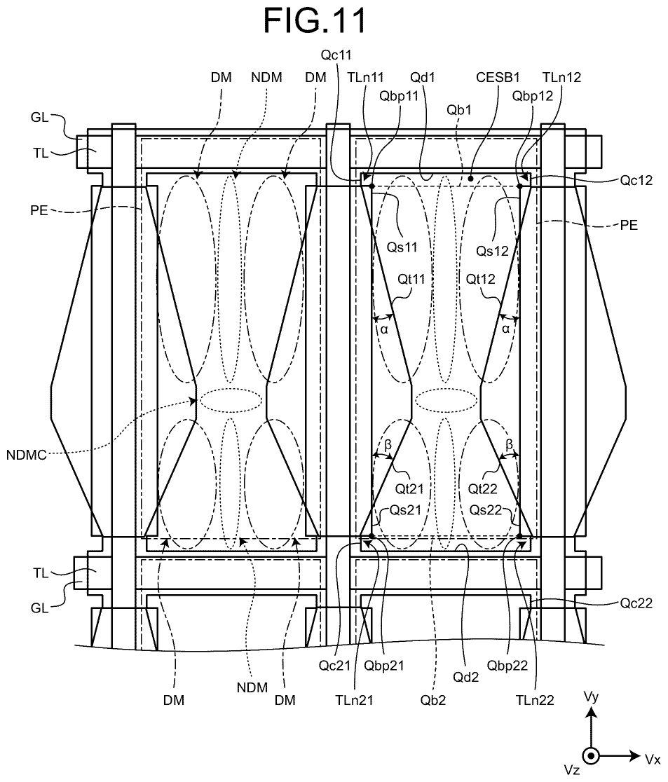

FIG. 10 is a plan view schematically illustrating the relation between slits and liquid crystal domains. FIG. 11 is a plan view schematically illustrating the relation between the slits and the liquid crystal domains according to a comparative example. The conductive layer TL according to the first embodiment illustrated in FIG. 10 has the division line portion TLA, whereas the conductive layer TL according to the comparative example illustrated in FIG. 11 does not have the division line portion TLA. Therefore, the pixel according to the comparative example illustrated in FIG. 11 has a dark region NDMC that is not present in the pixel according to the first embodiment illustrated in FIG. 10. As a result, the liquid crystal domains DM according to the first embodiment illustrated in FIG. 10 are more stable than in the comparative example illustrated in FIG. 11. The first embodiment illustrated in FIG. 10 improves the contrast compared with the comparative example illustrated in FIG. 11 because the division line portion TLA blocks more light than the dark region NDMC.

The first slit CES1 has a polygonal shape composed of a first trapezoidal region CEST1, a rectangular region CESB11, and a rectangular region CESB12. Similarly, the second slit CES2 has a polygonal shape composed of a second trapezoidal region CEST2, a rectangular region CESB21, and a rectangular region CESB22. Thus, the first slit CES1 and the second slit CES2 each include a trapezoidal shape at the part corresponding to the opening of the pixel Pix (refer to FIG. 6).

As illustrated in FIG. 10, the division line portion TLA is provided between a first side Qt11 and a third side Qt21 and between a second side Qt12 and a fourth side Qt22. Therefore, a fifth side Qa1 and a sixth side Qa2 extend in the direction in which the division line portion TLA extends.

As illustrated in FIG. 10, the first trapezoidal region CEST1 has the first side Qt11, the second side Qt12, the fifth side Qa1, and a seventh side Qb3. The fifth side Qa1 according to the first embodiment extends along the division line portion TLA. The fifth side Qa1 is the upper side of the trapezoid and connects the first side Qt11 and the second side Qt12. The seventh side Qb3 is the base of the trapezoid and connects the first side Qt11 and the second side Qt12. The first side Qt11 and the second side Qt12 face each other and are non-parallel. The distance between the first side Qt11 and the second side Qt12 decreases toward the fifth side Qa1. Therefore, the gap between the first side Qt11 and the second side Qt12 gradually decreases toward the second slit CES2.

The second trapezoidal region CEST2 has the third side Qt21, the fourth side Qt22, the sixth side Qa2, and an eighth side Qb4. The sixth side Qa2 according to the first embodiment extends along the division line portion TLA. The sixth side Qa2 is the upper side of the trapezoid and connects the third side Qt21 and the fourth side Qt22. The eighth side Qb4 is the base of the trapezoid and connects the third side Qt21 and the fourth side Qt22. The third side Qt21 and the fourth side Qt22 face each other and are non-parallel. The distance between the third side Qt21 and the fourth side Qt22 decreases toward the sixth side Qa2. Therefore, the gap between the third side Qt21 and the fourth side Qt22 gradually decreases toward the first slit CES1.

As illustrated in FIG. 10, the second trapezoidal region CEST2 is smaller than the first trapezoidal region CEST1. Therefore, the angle α between Vy (second direction) and the second side Qt12 is smaller than the angle β between the direction Vy (second direction) and the fourth side Qt22. Similarly, the angle α between Vy (second direction) and the first side Qt11 is smaller than the angle β between the direction Vy (second direction) and the third side Qt21. In plan view, each of the first side Qt11, the second side Qt12, the third side Qt21, and the fourth side Qt22 partly intersects the division line portion TLA and the first frame portion TLB, and the part surrounded by one of the first side Qt11, the second side Qt12, the third side Qt21, and the fourth side Qt22, the division line portion TLA, and the first frame portion TLB is triangular. This configuration stabilizes the liquid crystal domains DM along the first side Qt11, the second side Qt12, the third side Qt21, and the fourth side Qt22, thereby improving the transmittance.

The rectangular region CESB12 has the seventh side Qb3, a ninth side Qb1, an eleventh side Qs11, and a twelfth side Qs12. The eleventh side Qs11 and the twelfth side Qs12 are the ends of the first frame portions TLB at the part where the distance between the adjacent first frame portions TLB is smaller than the shortest distance in the direction Vx between the first side Qt11 and the second side Qt12. The seventh side Qb3 and the ninth side Qb1 are parallel. The eleventh side Qs11 and the twelfth side Qs12 are parallel. The eleventh side Qs11 and the twelfth side Qs12 are straight lines extending along the first frame portions TLB. The ninth side Qb1 is a straight line connecting corners Qbp11 and Qbp12 of the first frame portions TLB adjacent to the recesses TLn11 and TLn12.

The rectangular region CESB22 has the eighth side Qb4, a tenth side Qb2, a thirteenth side Qs21, and a fourteenth side Qs22. The eighth side Qb4 and the tenth side Qb2 are parallel. The thirteenth side Qs21 and the fourteenth side Qs22 are the ends of the first frame portions TLB at the part where the distance between the adjacent first frame portions TLB is smaller than the shortest distance in the direction Vx between the third side Qt21 and the fourth side Qt22. The thirteenth side Qs21 and the fourteenth side Qs22 are parallel. The thirteenth side Qs21 and the fourteenth side Qs22 are straight lines extending along the first frame portions TLB. The tenth side Qb2 is a straight line connecting corners Qbp21 and Qbp22 of the first frame portions TLB adjacent to the recesses TLn21 and TLn22.

The rectangular region CESB11 has the ninth side Qb1, a fifteenth side Qd1, a seventeenth side Qc11, and an eighteenth side Qc12. The ninth side Qb1 and the fifteenth side Qd1 are parallel. The seventeen side Qc11 and the eighteenth side Qc12 are parallel. The seventeenth side Qc11 is a straight line extending along the bottom of the recess TLn11. The eighteenth side Qc12 is a straight line extending along the bottom of the recess TLn12.

The rectangular region CESB21 has the tenth side Qb2, a sixteenth side Qd2, a nineteenth side Qc21, and a twentieth side Qc22. The tenth side Qb2 and the sixteenth side Qd2 are parallel. The nineteenth side Qc21 and the twentieth side Qc22 are parallel. The nineteenth side Qc21 is a straight line extending along the bottom of the recess TLn21. The twentieth side Qc22 is a straight line extending along the bottom of the recess TLn22.

In the first embodiment, the length of the first side Qt11 is equal to that of the second side Qt12. Thus, the first trapezoidal region CEST1 has an isosceles trapezoidal shape. The length of the third side Qt21 is equal to that of the fourth side Qt22. Thus, the second trapezoidal region CEST2 has an isosceles trapezoidal shape. The first trapezoidal region CEST1 may have an asymmetric trapezoidal shape where the length of the first side Qt11 is different from that of the second side Qt12. The second trapezoidal region CEST2 may have an asymmetric trapezoidal shape where the length of the third side Qt21 is different from that of the fourth side Qt22.

As illustrated in FIG. 10, when, for example, no voltage is applied to the liquid crystal layer LC, the liquid crystal molecules are initially oriented with their long axes extending in the direction toward the inner side of the first slit CES1 near the first side Qt11 and the second side Qt12. The liquid crystal molecules in the regions near the first side Qt11 and the second side Qt12 are inclined in the opposite directions with respect to the direction Vy. Similarly, when no voltage is applied to the liquid crystal layer LC, the liquid crystal molecules are initially oriented with their long axes extending in the direction toward the inner side of the second slit CES2 near the third side Qt21 and the fourth side Qt22. The liquid crystal molecules in the regions near the third side Qt21 and the fourth side Qt22 are inclined in the opposite directions with respect to the direction Vy.

By contrast, when voltage is applied to the liquid crystal layer LC, that is, in an ON state where an electric field is formed between the pixel electrode PE and the common electrode CE, the liquid crystal molecules are affected by the electric field, and their orientation state changes. The liquid crystal domains DM are generated near the first side Qt11 and the second side Qt12, and the transmittance is controlled in accordance with the voltage. Similarly, the liquid crystal domains DM are generated near the third side Qt21 and the fourth side Qt22, and the transmittance is controlled in accordance with the voltage. In the liquid crystal domain DM, a dark region NDM is formed where the orientation of the liquid crystal molecules hardly changes when voltage is applied to the liquid crystal layer LC.

When voltage is applied between the pixel electrode PE and the common electrode CE, the liquid crystal molecules in the regions near the first side Qt11 and the second side Qt12 rotate in the opposite directions from each other. When voltage is applied between the pixel electrode PE and the common electrode CE, the liquid crystal molecules in the regions near the third side Qt21 and the fourth side Qt22 rotate in the opposite directions from each other.

For example, when voltage is applied between the pixel electrode PE and the common electrode CE, the long axis direction of the liquid crystal molecules rotates clockwise in the region near the first side Qt11 and counterclockwise in the region near the second side Qt12. When voltage is applied between the pixel electrode PE and the common electrode CE, the long axis direction of the liquid crystal molecules rotates clockwise in the region near the fourth side Qt22 and counterclockwise in the region near the third side Qt21. Thus, when voltage is applied between the pixel electrode PE and the common electrode CE, the polarization state of incident linearly polarized light changes depending on the orientation state of the liquid crystal molecules as the linearly polarized light passes through the liquid crystal layer LC. An example of the rotation direction of the long axis direction of the liquid crystal molecules may be opposite to the direction described above.

Two liquid crystal domains DM are divided by the dark region NDM, and the liquid crystal molecules in the liquid crystal domains DM respond faster than those in liquid crystal display devices of a lateral electric field mode, such as fringe field switching (FFS) and in-plane switching (IPS).

The rectangular regions CESB11, CESB12, CESB21, and CESB22 make the liquid crystal domains DM stable. The display device according to the first embodiment can secure the regions of the liquid crystal domains DM if the pixel Pix becomes smaller for higher definition. Therefore, the display device according to the first embodiment can enhance the transmittance.

As described above, the gap between the first side Qt11 and the second side Qt12 gradually decreases toward the second slit CES2. The gap between the third side Qt21 and the fourth side Qt22 gradually decreases toward the first slit CES1. With this configuration, the first slit CES1 improves the stability of the liquid crystal orientation and makes the behavior of the liquid crystal molecules more stable than in a case where the first side Qt11 and the second side Qt12 are parallel. The second slit CES2 improves the stability of the liquid crystal orientation and makes the behavior of the liquid crystal molecules more stable than in a case where the third side Qt21 and the fourth side Qt22 are parallel.

The display region AA of the counter substrate SUB2 is provided with no light-blocking layer. This configuration reduces the effects of overlapping misalignment between the array substrate SUB1 and the counter substrate SUB2.

The display device 100 according to the first embodiment includes the array substrate SUB1, the counter substrate SUB2 facing the array substrate SUB1, and the liquid crystal layer LC including the liquid crystal molecules between the array substrate SUB1 and the counter substrate SUB2. The array substrate SUB1 includes a plurality of signal lines SL, a plurality of scanning lines GL, a plurality of pixel electrodes PE, a plurality of semiconductors SC, a common electrode CE, and a conductive layer TL. The signal lines SL are spaced apart in the direction Vx. The scanning lines GL are spaced apart in the direction Vy. Each of the pixel electrodes PE is provided for each opening of the pixel Pix surrounded by two adjacent signal lines SL and two adjacent scanning lines GL. The semiconductors SC are each provided to the pixel Pix. The common electrode CE overlaps the pixel electrodes PE via the seventh insulating film 17. The conductive layer TL is stacked directly on the common electrode CE. The conductive layer TL has a grid shape and has a light-blocking property.

The conductive layer TL includes the division line portion TLA, the first frame portion TLB, and the second frame portion TLC. The division line portion TLA divides the pixel Pix into two sections of the first section Pixd1 and the second section Pixd2. The first frame portion TLB overlaps the signal line SL. The second frame portion TLC overlaps the scanning line GL. The common electrode CE has the first slit CES1 and the second slit CES2 for each of the pixels Pix. The first slit CES1 is provided in the first section Pixd1 and has at least the first side Qt11 and the second side Qt12 facing the first side Qt11 in plan view. The second slit CES2 is provided in the second section Pixd2 and has at least the third side Qt21 and at least the fourth side Qt22 facing the third side Qt21 in plan view.

The gap between the first side Qt11 and the second side Qt12 gradually decreases toward the second slit CES2. Similarly, the gap between the third side Qt21 and the fourth side Qt22 gradually decreases toward the first slit CES1. The division line portion TLA is provided between the first side Qt11 and the third side Qt21 and between the second side Qt12 and the fourth side Qt22.

With the configuration above, the pixel Pix according to the first embodiment is caused to have a multi-domain configuration, thereby reducing the effects of the dark region NDM between the first slit CES1 and the second slit CES2. As a result, the behavior of the liquid crystal molecules near one of the first side Qt11, the second side Qt12, the third side Qt21, and the fourth side Qt22 is stabilized, and the transmittance is enhanced.

### Second Embodiment

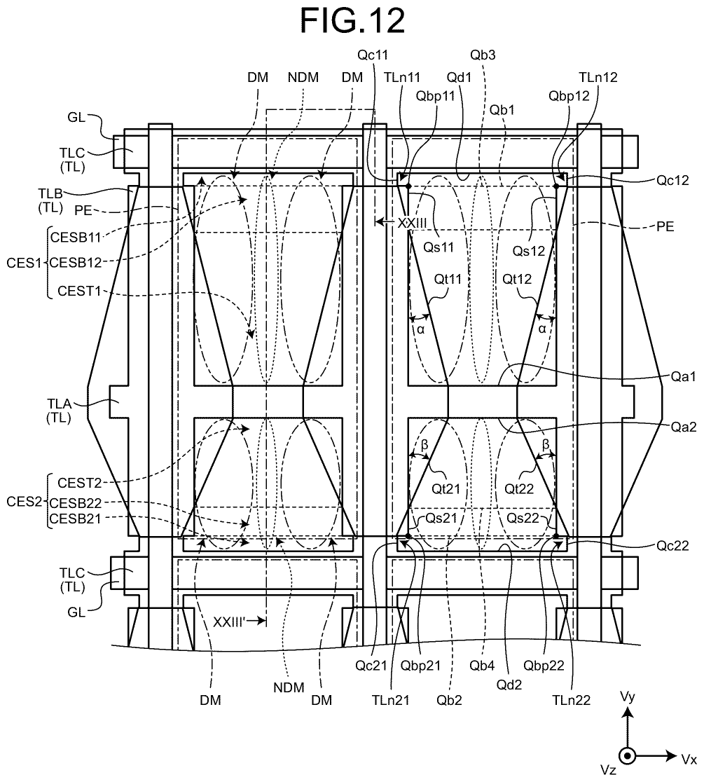

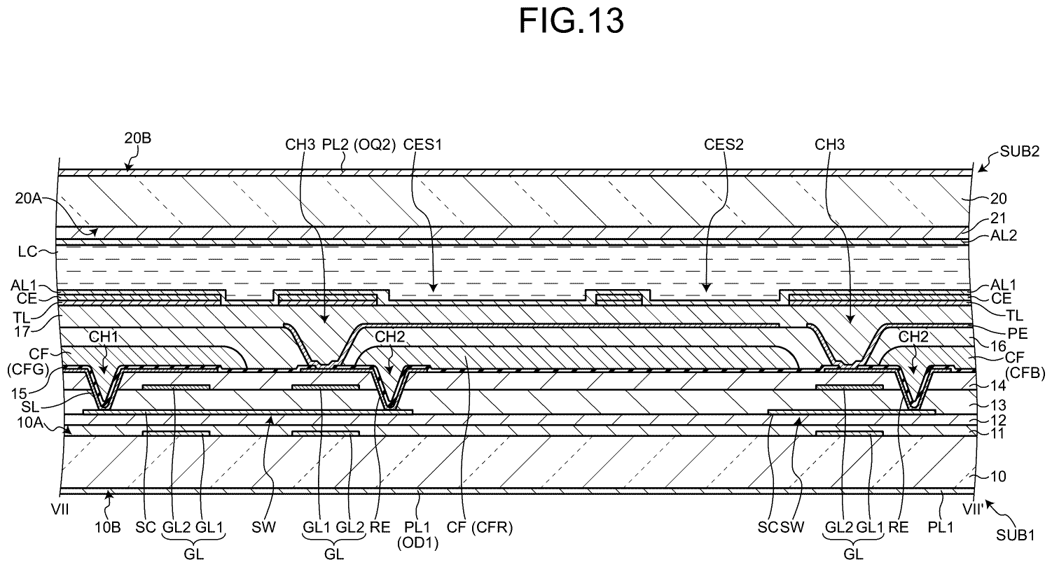

FIG. 12 is an enlarged schematic of part of the display region according to a second embodiment. FIG. 13 is a sectional view schematically illustrating the section along line XIII-XIII′ of FIG. 12. In the following description, components similar to those according to the first embodiment may be denoted by like reference numerals. Duplicate explanation thereof is omitted. The configuration according to the first embodiment has the third slit CES3 where the first slit CES1 and the second slit CES2 are connected at the part provided with no light-transmitting conductive material of the common electrode CE. The second embodiment is different from the first embodiment in that the region overlapping the division line portion TLA is also provided with the common electrode and that the first slit CES1 and the second slit CES2 are divided by the conductive material of the common electrode CE.

As illustrated in FIGS. 12 and 13, the slit CES of each pixel Pix includes the first slit CES1 and the second slit CES2.

By contrast, in the first slit CES1 according to the second embodiment, the intersection of the first side Qt11 with the fifth side Qa1 and the intersection of the second side Qt12 with the fifth side Qa1 tend to be rounded due to diffraction of exposure. In the second slit CES2 according to the first embodiment, the intersection of the third side Qt21 with the sixth side Qa2 and the intersection of the fourth side Qt22 with the sixth side Qa2 tend to be rounded due to diffraction of exposure. By contrast, the first slit CES1, the second slit CES2, and the third slit CES3 according to the first embodiment are collectively formed. With this configuration, if the division line portion TLA is not provided, none of the intersection between the first side Qt11 and the fifth side Qa1, the intersection between the second side Qt12 and the fifth side Qa1, the intersection between the third side Qt21 and the sixth side Qa2, and the intersection between the fourth side Qt22 and the sixth side Qa2 is present. Therefore, the shapes of the first side Qt11, the second side Qt12, the third side Qt21, and the fourth side Qt22 are less likely to be rounded, and the linear shapes are stabilized. If the division line portion TLA is formed to cover the third slit CES3, the intersection line between the division line portion TLA and the first slit CES1 serves as the fifth side Qa1, and the intersection line between the division line portion TLA and the second slit CES2 serves as the sixth side Qa2.

While the exemplary embodiments have been described, the embodiments are not intended to limit the present disclosure. The contents disclosed in the embodiments are given by way of example only, and various modifications may be made without departing from the spirit of the present disclosure. Appropriate modifications made without departing from the spirit of the present disclosure naturally fall within the technical scope of the present disclosure.

What is claimed is:

1. A display device comprising:
an array substrate;
a counter substrate facing the array substrate; and
a liquid crystal layer including a liquid crystal molecule between the array substrate and the counter substrate, wherein
the array substrate includes:
a plurality of signal lines spaced apart in a first direction;
a plurality of scanning lines spaced apart in a second direction;
a plurality of pixel electrodes, each pixel electrode being provided for each opening of a pixel surrounded by two adjacent signal lines and two adjacent scanning lines;
a plurality of semiconductors, each semiconductor being provided for each pixel;
a common electrode overlapping the pixel electrodes via an insulating film; and
a conductive layer stacked directly on the common electrode, the conductive layer having a grid shape and having a light-blocking property,
the conductive layer includes:
a frame portion overlapping the signal lines and the scanning lines; and
a division line portion dividing the pixel into two sections of a first section and a second section,
the common electrode includes a first slit and a second slit for each pixel, the first slit having at least a first side and a second side, the second side facing the first side in plan view and being provided in the first section, the second slit having at least a third side and a fourth side, the fourth side facing the third side in plan view and being provided in the second section,
a gap between the first side and the second side gradually decreases toward the second slit,
a gap between the third side and the fourth side gradually decreases toward the first slit, and
the division line portion is provided between the first side and the third side and between the second side and the fourth side.

2. The display device according to claim 1, wherein
coupling between the semiconductor and the pixel electrode is positioned in the first section, and
an area of the first section is larger than an area of the second section.

3. The display device according to claim 1, wherein, in plan view,
the first side, the second side, the third side, and the fourth side intersect the frame portion, and
a part surrounded by one of the first side, the second side, the third side, or the fourth side, the division line portion, and the frame portion is triangular.

4. The display device according to claim 1, wherein a distance between adjacent frame portions is partly smaller than a distance between the first side and the second side or a distance between the third side and the fourth side.

5. The display device according to claim 1, wherein
the first slit includes a trapezoidal shape having a fifth side, the fifth side connecting the first side and the second side and extending along the division line portion, and
the second slit includes a trapezoidal shape having a sixth side, the sixth side connecting the third side and the fourth side and extending along the division line portion.

6. The display device according to claim 1, further comprising a third slit by which the first slit and the second slit are coupled, the third slit being covered by the division line portion.

7. The display device according to claim 1, wherein, when voltage is applied between the pixel electrode and the common electrode, long axis directions of the liquid crystal molecules in regions near the first side and the third side rotate in opposite directions from each other and long axis directions of the liquid crystal molecules in regions near the second side and the fourth side rotate in opposite directions from each other.

8. A display system comprising:
a lens;
the display device according to claim 1; and
a control device configured to output an image to the display device.
